(19) United States
(12) Patent Application Publication
(10) Pub. No.: US 2002/0057289 A1
(43) Pub. Date: May 16, 2002

(54) User station providing localized manufacturing for personalized products

(76) Inventors: Jerry Crawford, Dallas, TX (US); Kari Hiltunen, Helsinki (FI)

Correspondence Address: STEVEN A. SHAW, NOKIA, INC., 6000 CONNECTION DRIVE, MD 1-4-755, IRVING, TX, 75039, US

(21) Appl. No.: 09/739,132

(22) Filed: Dec. 18, 2000

Related U.S. Application Data
(60) Provisional application No. 60/249,344, filed on Nov. 16, 2000.

(51) Int. Cl. G06F 13/00; G06F 3/00

(52) U.S. Cl. 345/744

(57) ABSTRACT

A method and a system are disclosed for providing a component customization and personalization function. The method comprises the steps of providing a user station including (a) a user interface, and (b) a manufacturing subsystem; enabling a user, via the user interface, to access a graphics subsystem to define a desired design to be placed on a consumer product; receiving, at the manufacturing subsystem, data descriptive of the desired design; and manufacturing, by the manufacturing subsystem at the user station, at least one component of the consumer product to have the desired design. A further step employs an e-commerce engine to conduct a financial transaction with the user in order to make an accounting for the manufactured component.

### CROSS REFERENCE TO RELATED APPLICATIONS

This application is related to and claims priority of Provisional Application No. 60/249,344 filed on Nov. 16, 2000.

### FIELD OF THE INVENTION

This invention relates generally to a methods and apparatus for conducting business transactions using a global data communications network, such as the Internet, and relates more particularly to methods and apparatus for enabling a consumer to use a global data communications network to select or create a personalized component of a consumer product, such as but not limited to a personalized cover component for a handheld communication device such as mobile station.

### BACKGROUND OF THE INVENTION

Consumer products, by their very nature, tend to be uniform in style and appearance within a particular model or group of models. For example, a particular model of mobile station will typically have a predetermined outer cover design and styling, and will be offered in one or at best a limited palette of colors. While this may suit the needs of many consumers, some consumers will desire to personalize their purchased product by changing the cover color and/or by adding graphical or textual images to the cover.

At present, it is known to provide snap-on replacement covers from the manufacturer or from third parties. Reference in this regard can be had to commonly assigned U.S. Pat. No. 5,768,370, issued Jun. 16, 1998, entitled “User Changeable Cosmetic Phone Interface”, to Veli-Matti Maatta, Gregor D. Magnusson and Frank Nuovo. These covers are available in different colors and with different graphical designs. While the use of such stock replacement covers may satisfy the need of some consumers to change the basic cover appearance of their mobile station, other consumers will desire to even further personalize their mobile station, such as by providing a cover having a color or colors that are not standard colors, and/or by adding a graphical image or images that are unique and/or that have some personal connection with the consumer, such as a photograph or a reproduction of a child's artwork.

A consumer who wished to obtain a customized cover might be able to do so by presenting a desired design to a manufacturing company or a graphic design company, and commissioning the company to build the cover to the consumer's specifications. However, such an operation would likely require several weeks before the manufactured item is delivered to the consumer. Many consumers would welcome an opportunity to specify a personalized design and obtain the finished product shortly thereafter.

### OBJECTS AND ADVANTAGES OF THE INVENTION

It is an object and advantage of this invention to provide a method and system for enabling a consumer to specify a design for a component of a consumer product at a station, where the component is thereafter manufactured at the station.

Other objects and advantages of this invention will become apparent in view of the description of the invention, including the appended claims.

### SUMMARY OF THE INVENTION

The foregoing and other problems are overcome by methods and apparatus in accordance with embodiments of this invention.

In accordance with an aspect of this invention a consumer is enabled to access an Internet site from a local station to select a decorative element by choosing from a set of decorative elements, or to create a decorative element by using templates and tools provided by the site, or to upload a digitized design element, such as a scanned artwork or photograph, to the Internet site. The consumer then places an order, an e-commerce transaction is initiated and completed, such as by entering a credit card or debit card number, and other pertinent information, a component is then manufactured at the local station so as to include the consumer's selected or created decorative element, and the consumer can obtain the completed component from the local station, shortly thereafter. In a presently preferred, but not limiting embodiment, the component is a cover, also referred to herein as a faceplate, or some other component, such as a display bezel, of a mobile station. In other embodiments the component could be a cover or other component, such as a display bezel, of some other type of personal communication device, such as a pager. The cover could also be a faceplate or other component of a handheld personal organizer. In other embodiments the external appearance of any suitable type of consumer product could be so designed or specified by the consumer, and then ordered and delivered.

A point-of-sale (POS) machine, kiosk or site is provided which enables the consumer to locally select, modify or create a desired image element, and/or to upload to a central site an artwork or a photograph that may have been enhanced or otherwise modified at the POS site using tools provided at the POS site. The POS site may be one of a plurality of POS sites that are networked (e.g., each may have a unique network address, such as a unique TCP/IP address) to facilitate the collection of sales data, service needs, inventory replenishment, downloading of new stock artwork and designs and the like. The desired graphical design element may be locally created at the POS site. The POS site also includes a capability to manufacture the component and thereby provide a completed component to a consumer in a relatively short period of time.

It may be preferred to review inputted and uploaded design elements, as well as those modified or created on-line or locally, in order to check for the possibility of content and trademark issues. Consumers may be requested to electronically “sign” a certification statement of ownership of the design element.

In general, the teachings of this invention pertain to a user station that gives consumers the ability to modify and customize the external appearance of a product that is manufactured at the user station. Examples include a consumer-installable product cover or faceplate that is constructed to include a consumer-selected, modified or created design, a product cover or faceplate or some other external component, such as buttons that are modified in shape, color and/or legends, a display window or lens that is modified in color or in some optical property (such as having magnification properties), and so forth.

Preferably, the component that is modifiable to include user-selected or created design is one that, when modified, does not adversely affect the underlying functionality of the product in any significant way.

A method and a system are thus disclosed for providing a component customization and personalization function at a user station within which the component is manufactered. The method provides a central site that has an interface to a communications network such as a LAN or the Internet, a set of predetermined designs and images, and a graphics server providing graphics tools for enabling a modification of the predetermined designs and images, and for further enabling the creation of new designs and images. The method also provides a user station coupled to the central site through the communications network. The user station includes a user interface for enabling a user to access the graphics tools for the purpose of at least one of selecting one of the predetermined designs as a desired design, or to create the desired design by at least one of modifying at least one of the predetermined designs and images, or by inputting the new design or a new image. The desired design is one that is to appear or be placed on a consumer product, such as a mobile station. The user station also includes a manufacturing subsystem. A next step receives, at the manufacturing subsystem, data descriptive of the desired design. A further step manufactures, at the manufacturing subsystem of the user station, at least one component of the consumer product, such as the faceplate of the mobile station, to have the desired design for delivery to the user. A further step employs the e-commerce engine to conduct a financial transaction with the user in order to make an accounting for the manufactured component.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is an overall block diagram of a Component Customization and Personalization System (CCPS) in accordance with the teachings of this invention;

FIG. 2 is a block diagram of the Central Site (CS) shown in FIG. 1;

FIG. 3 is a logic flow diagram in accordance with a method of this invention; and

FIG. 4 is an illustration of an exemplary faceplate produced in accordance with the teachings of the present invention.

### DETAILED DESCRIPTION OF THE INVENTION

As employed herein an “image” is considered to be a single graphical element, while a “design” is a graphic file representing, in the preferred embodiment, a cover or faceplate of a mobile station. In other embodiments a design is a graphic file representing some other type of cover or faceplate, such as a cover of a pager, or a cover of a personal organizer, or a cover of any desired consumer device, or in general a component of a desired consumer device. The desired design preferably includes some type of decorative element, although the design may also be functional in whole or in part, such as by including the name and/or other descriptive information of the owner or user of the mobile station.

A faceplate in the context of the presently preferred embodiment is a part of the exterior enclosure of the mobile station, more specifically that part through which the buttons and display protrude. However, the teachings of this invention could be applied as well to the back part or cover of the outer enclosure, and to both the faceplate and the back cover. The faceplate is preferred however, as it can be made user-installable, and typically does not have any structural or electronic components mounted to it, as the back cover typically does.

A mobile station may be a personal communicator, a wireless telephone, a cellular telephone, a pager, or any type of communication device or other type of device having communication capabilities.

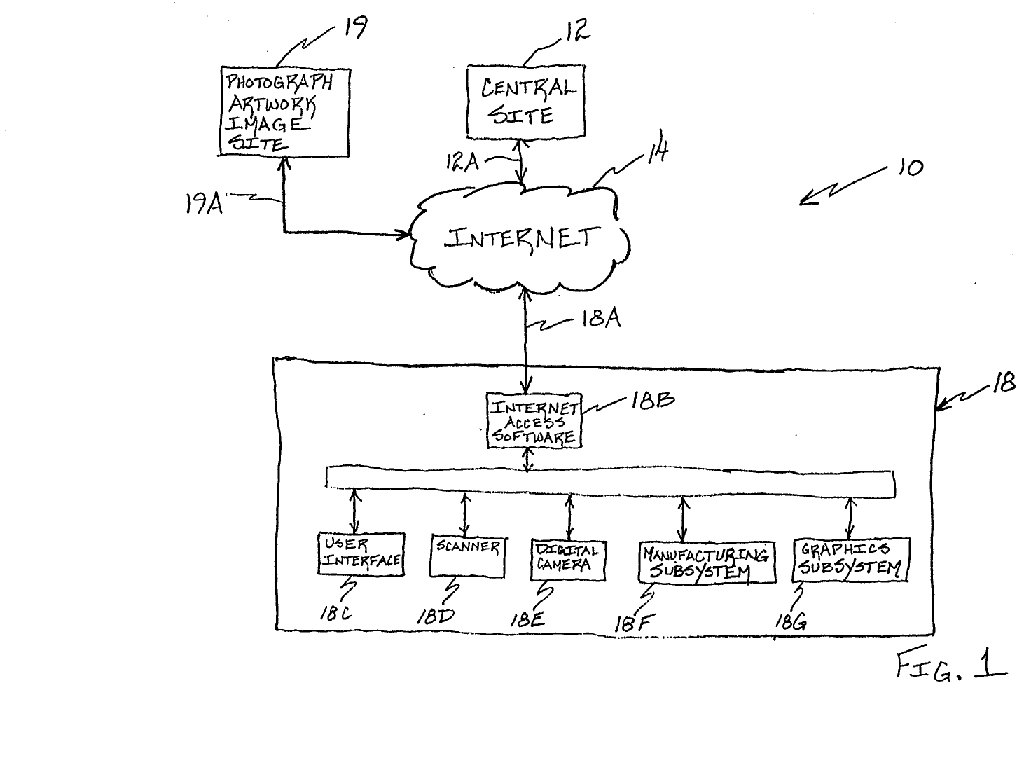

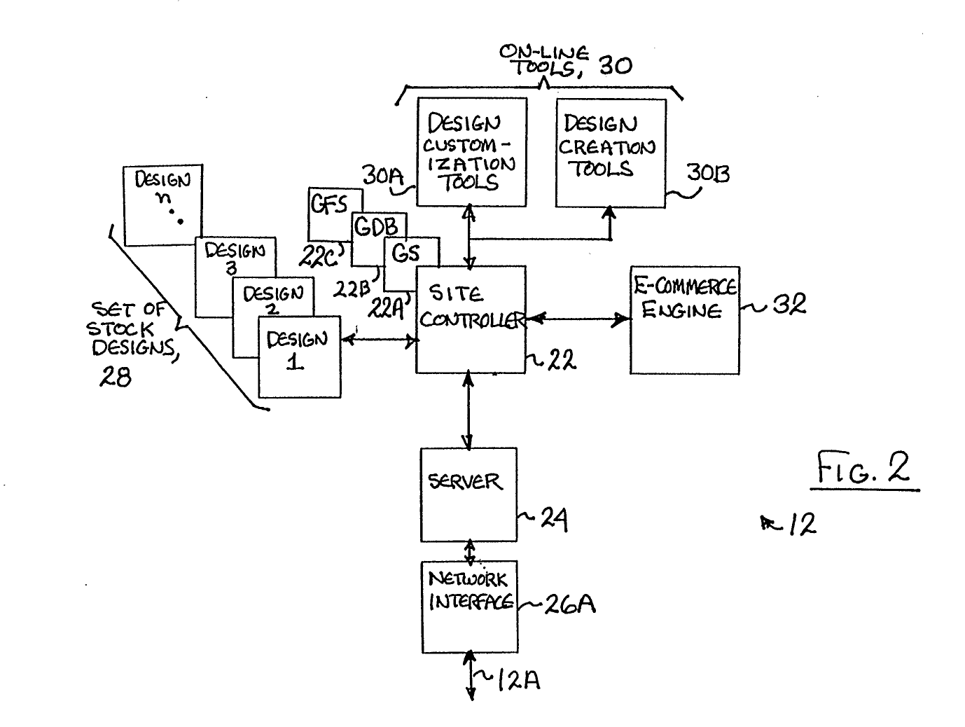

FIG. 1 depicts an overall block diagram of a Component Customization and Personalization System (CCPS) 10 in accordance with the teachings of this invention. The CCPS 10 includes a Central Site (CS) 12, shown in further detail in FIG. 2, that is bidirectionally coupled through link 12A to a data communications network such as the Internet 14. In other embodiments the data communications network may be a Local Area Network (LAN). The CS 12 is assumed to have a unique Internet TCP/IP address that can be reached from individual ones of a plurality of user stations 18, one of which is represented in FIG. 1.

The user stations 18 are each bidirectionally coupled to the Internet 18 via a link 18A, and include some type of Internet access software 18B and a graphical user interface 18C. Each user station 18 may also include a digital scanner 18D or some corresponding means for digitizing an image, such as a photograph or an artwork. The user stations 18 may also include an interface to a digital camera 18E, either one built into the user station 18 or one provided by a user of user station 18. Corresponding software can be provided to image process, enhance, crop, etc., a digital photograph, or this software could be resident at the central site 12. Each user station 18 can have a unique Internet address, thereby facilitating the collection of sales data, service needs, inventory replenishment, and the downloading from the central site 12 of new stock artwork, images, designs and the like.

Each user station 18 also includes a manufacturing subsystem 18F for manufacturing the customized or personalized component in accordance with design information and criteria provided by the user. Central site 12 is enabled to convey the necessary design information to the manufacturing subsystem 18F. The design information can be conveyed in, by example, JPEG format, CYMK color, 150 dpi.

Manufacturing subsystem 18F holds undecorated, unpainted components and finishes them with the specified design. Manufacturing subsystem 18F can also include tools for cutting, shaping or molding the component.

A suitable manufacturing system 18F may use the “Elina” manufacturing process of Nokia Research Center (Finland; Irving, Tex.) or direct UV-ink printing on mobile station surface. In the Elina process, the producer of manufacturing unit may be for example Ensto Audel Corporation of Finland.

In the Elina process, the blank cover is inserted by customer or the manufacturing unit may have a storage of blank mobile station covers or other components. The manufacturing may be capable of storing/processing many component types which user may choose. The manufacturing unit may also comprise forming tools to form the shape of the component. Each different shape of size of component requires a different forming tool. There may be provided storage of the tools. Tools may be required to be kept at a required temperature. Therefore, heat/cooling units may be required. Preform feeding may use feeding mechanisms such as those on copy machines.

The custom design may then be printed on a thin polymer film, (also referred to in the art as a foil), that may be produce from polycarbonate, Polyester, acrylics, Veralite, or other like polymer films.

The printing may be accomplished by using digital ink-jet or laser printing techniques. Other methods include but are not limited by silk screen, flexo, foil, pad, dye sublimation and the like. The preferred printing method is a pietzo-printer with UV-cureable ink. AN example of a printhead for this method is the XaarJet XJ64-360 from Xaar Ltd. (Cambridge, United Kingdom). After the ink is printed, the ink is not totally cured because in forming it is preferred that the ink be as flexible as possible. Additionally, the partially cured ink may act as an adhesion promoter so that separate glue may not be necessary. UV-inks will adhere on most surfaces without treatment. Solvent-based inks may need treatment especially for non-porous surfaces. Solvent-based inks may also dry in the application nozzles while UV-inks may stay in nozzles for long periods of time as long as the ink is not exposed to UV light.

The printed component is transferred to a forming stage where the printed film may be attached to the top of the component by using pressure and heat. The component acts as a mold so one POS-machine may decorate several different models of mobile stations. The pressure used in the process forms the film suitable for the component. The film preferably should go below the edge of the black component. If the support structure is designed correctly, keyholes, lensholes and the like do not need separate cutting. After forming, the decorated component is transferred to a cutting stage where the edges are cut by using laser or mechanical cutter. The component is now ready and the manufacturing unit dispenses the component to the customer. The Elina process may be done automatically in POS or semi-automatically in factory or office environment. Because the ink is between the blank cover and the film, the decoration is scratch resistant. The UV-inkjet may also be used to print directly on the cover. In this case, no separate protection is needed after the ink is cured by UV light.

In Elina process, one option may be usage of thin metal sheet. In this embodiment, the POS-machine does not use printing techniques—the metal sheet is directly attached to the top of the component by pressure. Of course, the UV-ink head can spread glue to the metal sheet before forming. With the metal sheet process, it is possible to use metals such as gold, platinium, copper and the like.

The CCPS 10 may also include one or more other sites, shown collectively as the site 19, that store or archive digital representations of photographs and/or digital representations of artworks. Site 19 is bidirectionally coupled to the Internet 14 via a link 19A. The site 19 could be associated with a photograph developer or film processor, a camera, a photographer, a museum, a public library, a government archive, the user's own site, or any site that provides access to digital representations of photographs and/or artworks. The user is enabled to access the site 19 through the Internet 14 from a user station 18 in order to download one or more selected digital representations of photographs and/or artworks.

FIG. 2 is a block diagram of the Central Site (CS) 12 shown in FIG. 1. A site controller 22, typically one or more data processors, is bidirectionally coupled to the Internet 14 via the link 12A, a network interface 26A and at least one server 24. The server 24 enables the site controller 22 to simultaneously interact with a plurality of user stations 18. One suitable embodiment for the server 24 is a Sun™ server running the Solaris™ operating system. The server 24/network interface 26A are assumed to be compatible with TCP/IP and to have a unique Internet network address.

Bidirectionally coupled to the site controller 22 is a set of stock designs and images 28 (design 1, design 2, . . . , design n) which are displayed to the user, preferably in a reduced “thumbnail” format, and from which a user is enabled to select, if desired, a specific design. The various stock designs and images 28 can include complete designs or portions thereof, such as background patterns and/or colors, and/or foreground images and/or colors. For example, the user may select a particular background pattern, and may also select one or more particular foreground images or patterns to superimpose on the selected background pattern to form a completed design. In general, the stock designs and images 28 can include text, graphics, photographs, animation stills, video stills, or other visual or textual information.

Preferably the designs in the set of stock designs and images are categorized by, for example, subject matter and/or artist's name. It is also preferred to categorize the individual images. It should be noted that certain ones of the images may be background textures (e.g., leather, straw, stone, wood, etc.).

Also bidirectionally coupled to the site controller 22 is, in the preferred embodiment, an on-line tools 30 resource. The tools resource 30 includes, but is not limited to, graphic (design) customization tools 30A and graphic (design) creation tools 30B. Using the customization tools 30A the user at a user station 18 is enabled to customize or modify a selected one or ones of the set of stock designs and images 28. For example, the user could select a stock background pattern that is an image of a leopard's spotted coat, and a stock foreground image of a leopard's head. Then by using the customization tools 30A the user may change or reverse the colors of the background pattern, and/or copy and replicate the foreground image some number of times (also known as tiling), apply transformations such resizing and also rotation to rotate one or all of the replicated foreground images, while superimposing the modified foreground image(s) on the modified background pattern.

Using the creation tools 30B the user from one of the user stations 18 is enabled to create a new design altogether. The provided tools include a drawing tool for forming lines, rectangles, ellipses and polygons, a tool for selecting and filling areas with color, a brush tool having adjustable brush style, line/border width, border color and fill color, and a color palette selection tool.

In some embodiments the functionality of the customization tools 30A and the creation tools 30B may be merged into one set of graphic processing tools implemented in a graphics program, or a graphics subsystem, a graphics server (GS) 22A, described in further detail below.

It should be appreciated that an ability is also provided to enter and manipulate textual data (names, words, phrases) and to select, for example, font faces, size, color, basic style (bold, italic, underlined) and alignment (vertical and horizontal). Advanced text effects, such as scale, skew, rotate and emboss, can be provided as well. The textual data can be merged with the image data to create the final design. It should further be appreciated that the foregoing tools 30A and 30B may also be employed to process an image that is uploaded (preferably in JPEG format) from the user from one of the user stations 18. Specialized software may also be provided, such as software suitable for use when processing digital photographs. The on-line graphics tools 30 function is also responsible for image compression and color conversion tasks.

Based on the foregoing, it can be appreciated that an important component of the site controller 22 is at least one graphics server (GS) 22A having an associated graphics database (GDB) 22B and a graphics file system (GFS) 22C. The GS 22A, GDB 22B and GFS 22C cooperate with one another to implement the functionality of the on-line tools 30. Any required database tables to support the various graphics tool features (e.g., Save Design, Bookmark Clipart, Save Uploaded Image) are stored in the GDB 22B. The contents of the set of stock designs and images 28 are themselves stored preferably, but not by way of limitation, in JPEG compressed format within the GFS 22C, while only their filenames are stored in the GDB 22B. Other suitable compression methods could be used as well. For the case where multiple graphics servers 22A are provided, the site controller 22 provides load balancing software to allocate new users so as not to overload one of the GSs 22A.

The graphics server 22A is preferably comprised of two major components, a downloadable Java applet that runs in the browser of each user station 18, and the central site-resident software of the graphics server 22A that handles requests from the applets.

It is within the scope of these teachings for the GS 22A to provide various filters and special effects, such as blur, sharpen, mosaic, pointilize, watercolor, pastels, brightness, contrast and other standard image effects.

During the design editing/creation process operations the user is presented with an outline or silhouette of the faceplate, with display window and button hole areas indicated. The display window and button hole areas are marked by the GS 22A as “non-drawable” areas. A grid may be superimposed over the faceplate silhouette to assist the user in placing images and textual information. Various models of mobile stations are preferably supported, with a different corresponding faceplate silhouette being provided for each supported model. Various conventional image and text editing features can be provided, such as cut, paste copy, undo, redo, etc.

During use of the online graphic tools 30 the user is presented with a preview of the design, typically at a lower resolution than the one maintained by the graphics server 22A. The final appearance of the completed design can then be previewed at the high resolution maintained by the graphics server 22A, preferably after being transformed to a three dimensional representation corresponding to the three dimensional shape of the component on which the design will appear. In the preferred embodiment the final appearance of the completed design is transformed or distorted such that the final appearance of the faceplate can be viewed from the front, left and right sides. If the appearance of the back cover is also modifiable, then both the faceplate and the back cover can be viewed together.

Furthermore, both the front faceplate and the back cover should be viewed together because the graphics should fit at the joining point in order to provide a pleasing appearance. With the Elina process, a wide spectrum of different materials may be used because the inkhead may spread the glue and because the forming temperatures may be very low. Therefore, there is no problem regarding the polymer melting. Additionally, fabrics, leather and other similar materials may also be used.

It is also within the scope of these teachings to enable a user to place his or her completed design into the set of stock designs and images 28 so that other users can have access to the user's completed design, either to use as is, or to serve as a starting point for their own custom design.

It is also within the scope of these teachings to enable the user to specify, in addition to the design, a material for the component. For example, the use may specify that the custom design be placed on a faceplate made of wood, or metal, or some other material.

It is also within the scope of these teachings to enable the user to specify other features of the mobile station, such as button size and/or display size, and then receive a customized mobile station having the desired features, possibly along with a personalized faceplate design, instead of just receiving the mobile station faceplate. Further in this regard certain other features of the mobile station could be specified from a menu of possible customizable features, such as default settings, the contents of a telephone number directory (names and telephone numbers), special tones and sounds, desired wake-up graphics and/or animations, a desired game or games to be loaded into the mobile station, and other features.

The central site 12 also includes an electronic commerce (e-commerce) engine 32 for generally accounting for the transaction of ordering the personalized component. The accounting function can include processing a user's credit card or debit card information, checking the user's credit, authenticating the user, logging the user's name, address and other information (such as the user's e-mail address), computing any state and local taxes that may need to be collected, computing shipping amounts, and maintaining overall records of the various transactions performed at the central site 12.

The user does not necessarily need to pay for the personalized component with his or her own funds. The user may receive a gift card, or the like, from a friend, relative or other third party. Also, the user could redeem loyalty points provided by a promoter. For example, a corporation may provide a free personalized component in exchange for displaying the corporate logo, or other logo or a slogan, on the personalized component.

Another function of the e-commerce engine 32 can include checking the design to determine if it contains any licensed content, and then calculating the appropriate royalty to be paid to the entity from which the content was licensed. The e-commerce engine 32 may also be responsible for checking the user's design, including any textual component thereof, to insure that it does not include any objectionable subject matter, or another functional module at the central site 12 (or linked to the central site 12) can be provided for this purpose. If objectionable content is found the transaction is refused, and the user may be given the opportunity to revise the design to eliminate the objectionable content. It is desirable to have the user electronically “sign” a certification that the user's design is owned by the user, and this function may also be handled by the e-commerce engine 32.

Techniques are also available to provide an authorization code showing proof of authorization to use proprietary content, such as copyrighted or trademarked material. U.S. Pat. No. 4,528,643, issued to Charles C. Freeny, Jr. on Jul. 9, 1985, provides a method for paying for proprietary content.

After having defined a particular design in cooperation with the user, and after initiating and completing the e-commerce transaction, data defining the completed design is forwarded by the site controller 22 to the manufacturing subsystem 18F where the design is applied to the component, such as a cover or faceplate for a mobile station. The final design is distorted, if necessary, so that the two dimensional design looks appropriate when placed on the three dimensional cover.

At the manufacturing subsystem 18F, the design can be applied by any suitable means to the stock component, such as the mobile station faceplate. The application can be by mechanical or laser engraving, molding, imprinting, screening, imaging, printing on a decal that is applied to the stock component, or by otherwise being placed on the stock component. For example, the user's design can be combined with an injection molding process so that the design is placed or formed into a mold, and the component then fabricated, using the mold, so as to incorporate the user's design in a visible location.

Design may also comprise functional elements such as displays, EM energy sensors, optical devices such as Dense Wave Multiple Access (DWMA) and Surface Acoustical wave (SAW) devices. Such devices may be created using methods for ink jet printing and self-creating structures such as surfactant-templated silica mesophase structures created using techniques currently under development by Jefferey Brinker et al. at Sandia Corporation (Albuquerque, N.M.) and other companies. Attention is directed to U.S. Pat. Nos. 5,057,296; 5,098,684; 5,858,457; 5,911,858; 5,949,071; 6,027,706; 6,037,612; 6,054,111; 6,057,377; and 6,090,545, all of which are herein incorporated by reference.

An example of a functional design is a Radio Frequency Identification (RFID) tag printed on the cover. U.S. patent application Ser. No. 09/675,618 filed on Sep. 29, 2000, which is assigned to assignee of the present application and herein incorporated by reference, discloses a removal cover incorporating an RFID tag using conductive ink to apply the tag to the removal cover.

The design can also be a changeable design when created with special inks consisting of nanometer-sized semiconductor particles such as those developed by Joseph Jacobson et al. Attention is directed to U.S. Pat. Nos. 5,930,026; 5,961,804; 6,017,584; 6,072,716; 6,118,426; 6,120,588; 6,120,839; and 6,130,773, all of which are herein incorporated by reference. The work on this technology has been conducted at MIT, and more recently at eink Corporation (www.eink.com).

A new component can be manufactured and the design then applied, or the design can be applied during the manufacturing process of the new component.

After manufacturing subsystem 18F applies the user's design to the component, the user obtains the completed component and installs the component on his or her device, such as by removing an existing mobile station faceplate and replacing same with the customized faceplate.

It should be realized that one or both of the central site 12 and the manufacturing subsystem 18F may store or archive data that represents the user's final design. In this manner the user is enabled to log-in to the central site 12, provide an identification, such as the user's name and a password, select a previous design from one or more displayed designs retrieved from the archive, and then recall and further modify the previous design. In a similar manner the user is enabled to log-in to the central site 12 and simply re-order a component having a previously completed design.

Aural information may be used in conjunction with the visual information, in accordance with an aspect of this invention, to provide additional value-added consumer features. For example, certain visual cover designs may have an associated and related aural ringing tone. In one example a faceplate design that includes an image of a composer may have an associated ringing tone adapted from a work of the composer. The user of one of the user stations 18 in this case is enabled to select and preview the associated ringing tone, possibly modify same using a provided audio tool (not shown), and then have the ringing tone downloaded to the user's mobile station using over-the-air or some other programming technique. It is also within the scope of this invention to enable the user to upload a desired sound file, in a similar manner as the user uploads an image, store and possibly modify the uploaded sound file at the central site 12, and to then have the uploaded sound file subsequently downloaded to the user's mobile station as a ringing tone.

Various graphical images for use as, by example, bit-mapped “wake-up” graphics on the display of the mobile station can be employed in the same manner, wherein the “wake-up” graphic may be in some manner related to the theme or content of the user's selected or created faceplate design. The “wake-up” graphical image may be customizable by the user as well, using the on-line tools 30 or similar tools, and then subsequently downloaded to the user's mobile station using over-the-air or some other programming technique.

Having thus described the presently preferred embodiments of the central site 12, it should be appreciated that much of the described functionality may be resident in some or all of the user stations 18. For example, user station 18 may include a local a graphics subsystem 18G that includes the set of stock designs and images 28, and may also include some or all of the on-line tools 30. In another embodiment user station 18 may include all of the functionality of the central site 12, with the exception of the e-commerce engine 32 and the server 24 functionality.

A user station 18 that includes a graphics subsystem may effectively operate as a stand-alone system. Such a user station 18 would nonetheless include a user interface 18C and a manufacturing subsystem 18F. The user interface 18C enables a user to access the graphics subsystem for defining a desired design to be placed on a consumer product. The manufacturing subsystem 18F receives data descriptive of the desired design, and manufactures, at user station 18, at least one component of the consumer product to have the desired design.

The user stations 18 can be placed at dealer locations (e.g., dealers that sell mobile stations and services), in shopping malls, in airports, or anywhere that makes it convenient for users to find and operate them.

The user stations 18 may be considered to be point-of-sale (POS) machines, and may resemble a kiosk. Each can be provided with the necessary functionality to enable the user to locally select, modify or create a desired image or design, and/or to upload to the central site 12 artwork or a photograph that may have been enhanced or otherwise modified at the user station 18 using appropriate graphic tools provided at the local site. As was stated earlier, the user stations 18 may be networked together (e.g., each may have a unique network address, such as a unique TCP/IP Internet 14 address) to facilitate the collection of sales data, service needs, inventory replenishment, and the downloading of stock designs and images.

Based on the foregoing description it can be appreciated that the inventors have also described a method for providing a component customization and personalization function. In brief, the method includes the steps of providing a user station having (a) a user interface, and (b) a manufacturing subsystem; enabling a user, via the user interface, to access a graphics subsystem to define a desired design to be placed on a consumer product; receiving, at the manufacturing subsystem, data descriptive of the desired design; and manufacturing, by the manufacturing subsystem at the user station, at least one component of the consumer product to have the desired design.

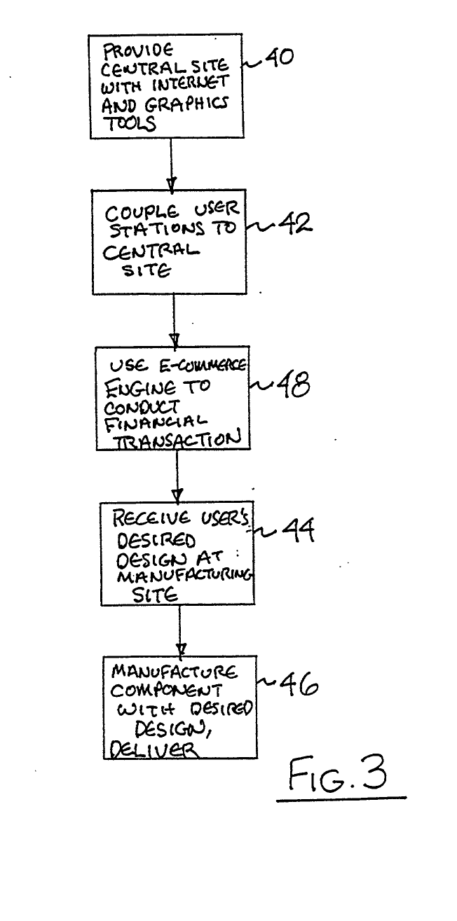

Referring to FIG. 3, this method includes a preferred step 40 of providing the central site 12 having an interface to a communications network, such as the Internet 14, a set of predetermined designs and images 28, and a graphics server 22A providing graphics tools 30 for enabling a modification of the predetermined designs and images, and for further enabling the creation of new designs and images.

Step 42 provides a user station 18, by coupling user station 18 to the central site 12 through the global communications network 14. The user station 18 includes a user interface 18C, such as a Java applet, for enabling a user to access the graphics tools 30 for the purpose of at least one of selecting one of the predetermined designs as a desired design or to create the desired design by at least one of modifying at least one of the predetermined designs and images or by inputting the new design or a new image. The desired design is one that is to appear or be placed on a consumer product, such as a mobile station. User station 18 also includes a manufacturing subsystem 18F for manufacturing, at user station 18, at least one component of the consumer product to have the desired design.

Step 44 receives, at manufacturing subsystem 18F, data descriptive of the desired design.

Step 46 manufactures, at manufacturing subsystem 18F, at least one component of the consumer product, such as the faceplate of a mobile station, to have the desired design for delivery to the user.

A further step 48, which typically is executed prior to step 44, employs the e-commerce engine 32 to conduct a financial transaction with the user in order to make an accounting for the manufactured at least one component.

While described above in the context of selecting, modifying or creating a design for the faceplate and/or the back cover of a mobile station, in some embodiments the desired design may be intended for a replaceable battery module, and in this case the user may receive, from manufacturing subsystem 18F, a replacement battery module having the desired design placed thereon. The desired design can also include a surface texture that is molded or otherwise formed into or onto the surface of the mobile station component.

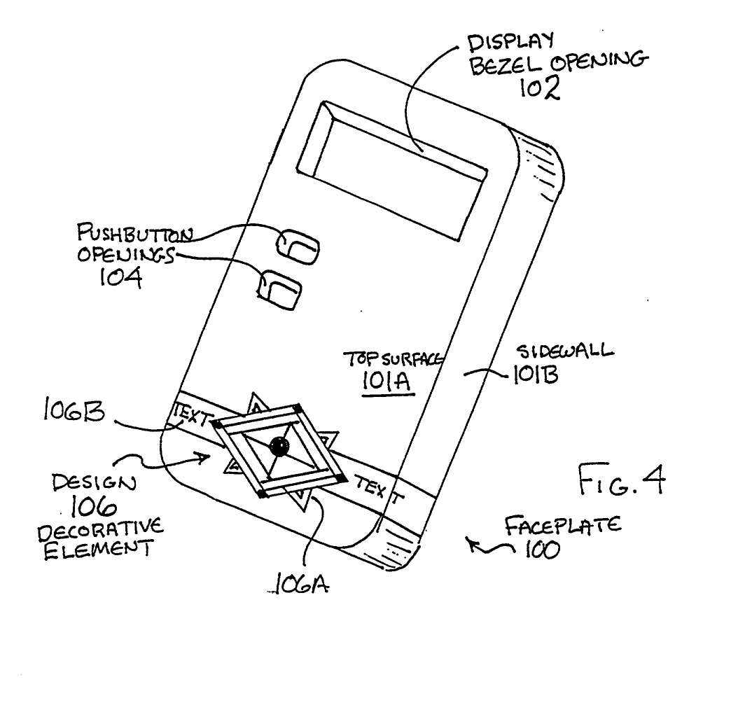

FIG. 4 is an illustration of an exemplary faceplate 100 produced in accordance with the teachings of the present invention. Faceplate 100 includes a top surface 101A, a sidewall 101B, a display bezel opening 102 and pushbutton openings 104. A user has specified a design 106 that includes an emblem 106A accompanied by text 106B.

Thus, while the invention has been particularly shown and described with respect to preferred embodiments thereof, it will be understood by those skilled in the art that changes in form and details may be made therein without departing from the scope and spirit of the invention.

What is claimed is:

1. A Component Customization and Personalization System (CCPS) comprising:
a central site comprising an interface to a communications network, said central site further comprising a set of predetermined designs and images and a graphics server providing graphics tools for enabling a modification of said predetermined designs and images, and for further enabling the creation of new designs and images;
a user station coupled to said central site through said communications network, said user station comprising:
(a) a user interface for enabling a user to access said graphics server for defining a desired design to be placed on a consumer product; and
(b) a manufacturing subsystem for receiving data descriptive of said desired design, and for manufacturing, at said user station, at least one component of said consumer product to have said desired design.

2. The CCPS of claim 1, wherein said central site further comprises an electronic commerce engine for conducting a financial transaction with the user in order to make an accounting for the manufactured at least one component.

3. The CCPS of claim 1, wherein said central site further comprises means for enabling the user to include the desired design into said set of predetermined designs and images.

4. The CCPS of claim 1, wherein said user interface enables the user to access said graphics server for the purpose of selecting one of said predetermined designs as a desired design.

5. The CCPS of claim 1, wherein said user interface enables the user to access said graphics server for the purpose of creating said desired design by modifying at least one of said predetermined designs and images.

6. he CCPS of claim 1, wherein said user interface enables the user to access said graphics server for the purpose of creating said desired design by inputting the new design or a new image.

7. The CCPS of claim 6, wherein the user inputs a new design or image by digitally scanning an artwork or a photograph.

8. The CCPS of claim 6, wherein the user inputs the new design or image by outputting digital data from a digital camera.

9. The CCPS of claim 6, wherein the user inputs the new design or image by outputting digital data from a memory card.

10. The CCPS of claim 1, wherein said at least one user station comprises a point-of-sale (POS) terminal.

11. A Component Customization and Personalization System (CCPS) comprising:
a central site comprising an interface to a communications network, said central site further comprising a set of predetermined designs and images and an electronic commerce engine for conducting a financial transaction with the user; and
a user station coupled to said central site through said communications network, said at least one user station comprising:
(a) a user interface for enabling a user to access a graphics program for defining a desired design to be placed on a consumer product, the graphics program implementing graphics tools for enabling a modification of said predetermined designs and images, and for further enabling the creation of new designs and images; and
(b) a manufacturing subsystem for receiving data descriptive of said desired design, and for manufacturing, at said user station, at least one component of said consumer product to have said desired design.

12. The CCPS of claim 11, wherein said electronic commerce engine accepts a payment from the user in a form selected from the group consisting of a credit card, a debit card, a gift card, and a redemption of loyalty points.

13. A Component Customization and Personalization System (CCPS), comprising:
a central site comprising an interface to the Internet, said central site further comprising a set of predetermined designs and images and an electronic commerce engine for conducting a financial transaction with the user;
a user station coupled to said central site through the Internet, said user station comprising:
(a) a user interface for enabling a user to access a graphics program for defining a desired design to decorate at least one component of a mobile station, the graphics program implementing graphics tools for enabling a modification of said predetermined designs and images, and for further enabling the creation of new designs and images; and
(b) a manufacturing subsystem for receiving data descriptive of said desired design, and for manufacturing, at said user station, at least one component of said consumer product to have said desired design.

14. A Component Customization and Personalization System (CCPS) user station comprising:
a user interface for enabling a user to access a graphics subsystem for defining a desired design to be placed on a consumer product; and
a manufacturing subsystem for receiving data descriptive of said desired design, and for manufacturing, at said user station, at least one component of said consumer product to have said desired design.

15. The CCPS user station of claim 14, further comprising an interface for accessing an electronic commerce engine for conducting a financial transaction with the user in order to make an accounting for the manufactured at least one component.

16. The CCPS user station of claim 14, wherein said graphics subsystem comprises a set of predetermined designs and images, and a graphics tool for enabling a modification of said predetermined designs and images and for further enabling the creation of new designs and images.

17. The CCPS user station of claim 16, wherein said graphics subsystem enables the user to include the desired design into said set of predetermined designs and images.

18. The CCPS user station of claim 16, wherein said user interface enables the user to access said graphics subsystem for the purpose of selecting one of said predetermined designs as a desired design.

19. The CCPS user station of claim 16, wherein said user interface enables the user to access said graphics subsystem for the purpose of creating said desired design by modifying at least one of said predetermined designs and images.

20. The CCPS user station of claim 16, wherein said user interface enables the user to access said graphics subsystem for the purpose of creating said desired design by inputting the new design or a new image.

21. The CCPS user station of claim 20, wherein the user inputs a new design or image by digitally scanning an artwork or a photograph.

22. The CCPS user station of claim 20, wherein the user inputs the new design or image by outputting digital data from a digital camera.

23. The CCPS user station of claim 20, wherein the user inputs the new design or image by outputting digital data from a memory card.

24. The CCPS user station of claim 14, further comprising a point-of-sale (POS) terminal.

25. The CCPS user station of claim 14, wherein said consumer product is a mobile station.

26. The CCPS user station of claim 25, wherein said at least one component is a cover component of said mobile station.

27. The CCPS user station of claim 25, wherein said user interface further enables a user to at least one of select, modify or create an audible signal for use with said mobile station.

28. The CCPS user station of claim 25, wherein said user interface further enables a user to at least one of select, modify or create a graphical image for use with said mobile station.

29. A method for providing a component customization and personalization function, comprising the steps of:
providing a central site comprising an interface to a communications network, a set of predetermined designs and images, and a graphics server providing graphics tools for enabling a modification of the predetermined designs and images, and for further enabling a creation of new designs and images;
coupling a plurality of user stations to the central site through the communications network, each of the user stations comprising (a) a user interface for enabling a user to access the graphics server to perform a step of defining a desired design to be placed on a consumer product, and (b) a manufacturing subsystem;
receiving, at said manufacturing subsystem, data descriptive of the desired design; and
manufacturing at said manufacturing subsystem at least one component of the consumer product to have the desired design.

30. The method of claim 29, wherein the central site further comprises an electronic commerce engine for conducting a financial transaction with the user in order to make an accounting for the manufactured at least one component.

31. The method of claim 29, further comprising a step of enabling the user to include the desired design into the set of predetermined designs and images.

32. The method of claim 29, wherein the step of defining a desired design comprises selecting one of the predetermined designs as the desired design.

33. The method of claim 29, wherein the step of defining a desired design comprises modifying at least one of the predetermined designs and images.

34. The method of claim 29, wherein the step of defining a desired design comprises inputting the new design or a new image.

35. The method of claim 34, wherein the user inputs a new design or image by digitally scanning an artwork or a photograph.

36. The method of claim 34, wherein the user inputs the new design or image by outputting digital data from a digital camera.

37. The method of claim 34, wherein the user inputs the new design or image by outputting digital data from a memory card.

38. The method of claim 29, wherein at least one of the user stations is comprised of a point-of-sale (POS) terminal.

39. A method for providing a component customization and personalization function, comprising the steps of:
providing a user station comprising (a) a user interface, and (b) a manufacturing subsystem;
enabling a user, via said user interface, to access a graphics subsystem to define a desired design to be placed on a consumer product;
receiving, at said manufacturing subsystem, data descriptive of the desired design; and
manufacturing, by said manufacturing subsystem at said user station, at least one component of the consumer product to have the desired design.

40. The method of claim 39, further comprising a step of accessing an electronic commerce engine for conducting a financial transaction with the user in order to make an accounting for the manufactured at least one component.

41. The method of claim 39, further comprising a step of enabling the user to include the desired design into the set of predetermined designs and images.

42. The method of claim 39, further comprising a step of enabling the user to include the desired design into a set of predetermined designs and images.

43. The method of claim 39, wherein the step of enabling the user to access the graphics subsystem comprises enabling the user to select one of a set of predetermined designs as the desired design.

44. The method of claim 39, wherein the step of enabling the user to access the graphics subsystem comprises enabling the user to modify at least one of a set of predetermined designs and images.

45. The method of claim 39, wherein the step of enabling the user to access the graphics subsystem comprises enabling the user to input a new design or a new image.

46. The method of claim 45, wherein the user inputs a new design or image by digitally scanning an artwork or a photograph.

47. The method of claim 45, wherein the user inputs the new design or image by outputting digital data from a digital camera.

48. The method of claim 45, wherein the user inputs the new design or image by outputting digital data from a memory card.

49. The method of claim 39, wherein said user stations is comprised of a point-of-sale (POS) terminal.
